(19) United States
(12) Patent Application Publication
(10) Pub. No.: US 2020/0126144 A1
(43) Pub. Date: Apr. 23, 2020

(54) System, Method, and Computer Program Product for Generating Recommendations Based on Predicted Activity External to a First Region

(71) Applicant: Visa International Service Association, San Francisco, CA (US)

(72) Inventors: Dongxu Shao, Singapore (SG); Chen Tung Michael Kao, Singapore (SG); Hong Wu, Beijing (CN)

(21) Appl. No.: 16/629,448

(22) PCT Filed: Jul. 10, 2017
(86) PCT No.: PCT/US2017/041307

§ 371 Date: Jan. 8, 2020

(51) Int. Cl. G06Q 30/06; G06N 5/04

(52) U.S. Cl. CPC G06Q 30/0631; G06N 5/04

(57) ABSTRACT

A method of generating recommendations based on predicted activity external to a first region includes segmenting a plurality of users into at least a first subset of users and a second subset of users. The method also includes generating an activation metric for each user of the first and second subset of users. The method also includes determining a plurality of target users from the plurality of users. The method also includes automatically initiating a target action for each target user. A system and computer program product for generating recommendations based on predicted activity external to a first region is also disclosed.

### BACKGROUND OF THE INVENTION

### Field of the Invention

The present invention is directed to generating recommendations for users and, in one particular embodiment, to a system, method, and computer program product for generating recommendations based on predicted activity external to a first region.

### Description of Related Art

Portable financial devices, such as credit cards, debit cards, and/or electronic wallet applications, allow users the flexibility to make purchases outside of the user's home country. In contrast, using cash for foreign transactions often requires users to first go to a financial institution to exchange home currency for foreign currency, which can include additional fees imposed by the financial institution for performing the currency exchange.

Because users traveling to foreign countries are away from their homes, their spending may oftentimes be increased for the duration of the travel. For instance, travelers often purchase meals, transportation, overnight accommodations, souvenirs, and items unintentionally left at home (e.g., clothing, toiletries, and/or the like) more frequently compared to when not traveling. Thus, overall, spending while traveling in a foreign country may be increased for many users, making benefits provided by portable financial device issuing institutions and/or transaction service providers more useful to travelers. Further, users traveling in a foreign country, because of their increased spending and based on higher interchange and foreign country conversion fees compared to domestic transactions, are a highly sought-after segment by portable financial device issuing institutions and acquirers.

Therefore, there is a need in the art for portable financial device issuing institutions and/or transaction service providers to be able to determine a user's propensity to make purchases in a foreign country using their portable financial device and to increase the volume of these purchases. In certain countries, such as China, details regarding domestic transactions are not available to issuing institutions and/or transaction service providers, meaning any determination of a user's propensity to make purchases in a foreign country using their portable financial device must be made without this information. Being able to determine this travel propensity allows the issuing institutions and/or transaction service providers to offer the user timely travel benefits and/or incentives.

### SUMMARY OF THE INVENTION

Accordingly, it is an object of the present invention to provide a method, system, and computer program product for automatically initiating at least one target action for at least one target user in a first region having a propensity for initiating transaction activity in at least one second region.

According to a non-limiting embodiment or aspect, provided is a computer-implemented method of generating recommendations based on predicted activity external to a first region. The method includes segmenting, with at least one processor, a plurality of users into at least a first subset of users and a second subset of users, the first subset of users including users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times. The method also includes generating, with at least one processor, an activation metric for each user of the first subset of users based at least partially on a frequency and/or temporal distribution of transactions external to the first region initiated by other users of the first subset of users. The method also includes generating, with at least one processor, an activation metric for each user of the second subset of users based at least partially on previous transaction data for at least a portion of the plurality of users. The method also includes determining, with at least one processor, a plurality of target users from the plurality of users based at least partially on the activation metric for each user of the plurality of users, the plurality of target users having a propensity for initiating transaction activity external to the first region. The method also includes automatically initiating, with at least one processor, at least one target action for each target user of the plurality of target users

In one non-limiting embodiment or aspect, the method may further include determining, with at least one processor, at least one predicted second region external to the first region for each target user of the plurality of target users. The method may further include: determining, with at least one processor, at least one predicted second region external to the first region for each target user from the first subset of users based at least partially on previous transaction history external to the first region for the target user and other users of the first subset of users; and determining, with at least one processor, at least one predicted second region external to the first region for each target user from the second subset of users based at least partially on other users of the plurality of users that were previously inactive for the predetermined time period and subsequently initiated transaction activity external to the first region.

In one non-limiting embodiment or aspect, the at least one target action may include identifying at least one offer for each user of the plurality of target users and communicating the at least one offer to the user. The at least one target action may include approving at least one of the plurality of target users for transactions in the at least one second region. The at least one target action may include generating at least one list of at least a portion of the plurality of target users associated with a first issuing institution and communicating the at least one list to the first issuing institution. The first region may a country or territory associated with each of the plurality of users. The predetermined time period may be twelve months. The predetermined number of times may be one.

According to a non-limiting embodiment or aspect, a system for generating recommendations based on predicted activity external to a first region, including at least one server computer including at least one processor, the at least one server computer programmed or configured to: segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times; generate an activation metric for each user of the first subset of users based at least partially on a frequency and/or temporal distribution of transactions external to the first region initiated by other users of the first subset of users; generate an activation metric for each user of the second subset of users based at least partially on previous transaction data for at least a portion of the plurality of users; determine a plurality of target users from the plurality of users based at least partially on the activation metric for each user of the plurality of users, the plurality of target users having a propensity for initiating transaction activity external to the first region; and automatically initiate at least one target action for each target user of the plurality of target users.

In one non-limiting embodiment or aspect, the at least one server computer may be further programmed or configured to determine at least one predicted second region external to the first region for each target user of the plurality of target users. The at least one server computer may be further programmed or configured to determine at least one predicted second region external to the first region for each target user from the first subset of users based at least partially on previous transaction history external to the first region for the target user and other users of the first subset of users and determine at least one predicted second region external to the first region for each target user from the second subset of users based at least partially on other users of the plurality of users that were previously inactive for the predetermined time period and subsequently initiated transaction activity external to the first region.

In one non-limiting embodiment or aspect, the at least one target action may include identifying at least one offer for each user of the plurality of target users and communicating the at least one offer to the user. The at least one target action may include approving at least one of the plurality of target users for transactions in the at least one second region. The at least one target action may include generating at least one list of at least a portion of the plurality of target users associated with a first issuing institution and communicating the at least one list to the first issuing institution. The first region may include a country or territory associated with each of the plurality of users. The predetermined number of times may be one.

According to a non-limiting embodiment or aspect, a computer program product for generating recommendations based on predicted activity external to a first region includes at least one non-transitory computer-readable medium including program instructions that, when executed by at least one computer including at least one processor, cause the at least one processor to: segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times; generate an activation metric for each user of the first subset of users based at least partially on a frequency and/or temporal distribution of transactions external to the first region initiated by other users of the first subset of users; generate an activation metric for each user of the second subset of users based at least partially on previous transaction data for at least a portion of the plurality of users; determine a plurality of target users from the plurality of users based at least partially on the activation metric for each user of the plurality of users, the plurality of target users having a propensity for initiating transaction activity external to the first region; and automatically initiate at least one target action for each target user of the plurality of target users.

In one non-limiting embodiment or aspect, the program instructions, when executed by the at least one computer including the at least one processor, may cause the at least one processor to determine at least one predicted second region external to the first region for each target user of the plurality of target users. The program instructions, when executed by the at least one computer including the at least one processor, may cause the at least one processor to determine at least one predicted second region external to the first region for each target user from the first subset of users based at least partially on previous transaction history external to the first region for the target user and other users of the first subset of users and determine at least one predicted second region external to the first region for each target user from the second subset of users based at least partially on other users of the plurality of users that were previously inactive for the predetermined time period and subsequently initiated transaction activity external to the first region.

In one non-limiting embodiment or aspect, the at least one target action may include identifying at least one offer for each user of the plurality of target users and communicating the at least one offer to the user. The at least one target action may include approving at least one of the plurality of target users for transactions in the at least one second region. The at least one target action may include generating at least one list of at least a portion of the plurality of target users associated with a first issuing institution and communicating the at least one list to the first issuing institution. The first region may include a country or territory associated with each of the plurality of users. The predetermined number of times may be one.

Further non-limiting embodiments or aspects will now be set forth in the following numbered clauses.

Clause 1: A computer-implemented method of generating recommendations based on predicted activity external to a first region, comprising: segmenting, with at least one processor, a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times; generating, with at least one processor, an activation metric for each user of the first subset of users based at least partially on a frequency and/or temporal distribution of transactions external to the first region initiated by other users of the first subset of users; generating, with at least one processor, an activation metric for each user of the second subset of users based at least partially on previous transaction data for at least a portion of the plurality of users; determining, with at least one processor, a plurality of target users from the plurality of users based at least partially on the activation metric for each user of the plurality of users, the plurality of target users having a propensity for initiating transaction activity external to the first region; and automatically initiating, with at least one processor, at least one target action for each target user of the plurality of target users.

Clause 2: The method of clause 1, further comprising determining, with at least one processor, at least one predicted second region external to the first region for each target user of the plurality of target users.

Clause 3: The method of clause 1 or 2, further comprising: determining, with at least one processor, at least one predicted second region external to the first region for each target user from the first subset of users based at least partially on previous transaction history external to the first region for the target user and other users of the first subset of users; and determining, with at least one processor, at least one predicted second region external to the first region for each target user from the second subset of users based at least partially on other users of the plurality of users that were previously inactive for the predetermined time period and subsequently initiated transaction activity external to the first region.

Clause 4: The method of any of clauses 1-3, wherein the at least one target action comprises: identifying at least one offer for each user of the plurality of target users; and communicating the at least one offer to the user.

Clause 5: The method of any of clauses 1-4, wherein the at least one target action comprises approving at least one of the plurality of target users for transactions in the at least one second region.

Clause 6: The method of any of clauses 1-5, wherein the at least one target action comprises: generating at least one list of at least a portion of the plurality of target users associated with a first issuing institution; and communicating the at least one list to the first issuing institution.

Clause 7: The method of any of clauses 1-6, wherein the first region comprises a country or territory associated with each of the plurality of users.

Clause 8: The method of any of clauses 1-7, wherein the predetermined time period is twelve months.

Clause 9: The method of any of clauses 1-8, wherein the predetermined number of times is one.

Clause 10: A system for generating recommendations based on predicted activity external to a first region, comprising at least one server computer including at least one processor, the at least one server computer programmed or configured to: segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times; generate an activation metric for each user of the first subset of users based at least partially on a frequency and/or temporal distribution of transactions external to the first region initiated by other users of the first subset of users; generate an activation metric for each user of the second subset of users based at least partially on previous transaction data for at least a portion of the plurality of users; determine a plurality of target users from the plurality of users based at least partially on the activation metric for each user of the plurality of users, the plurality of target users having a propensity for initiating transaction activity external to the first region; and automatically initiate at least one target action for each target user of the plurality of target users.

Clause 11: The system of clause 10, wherein the at least one server computer is further programmed or configured to determine at least one predicted second region external to the first region for each target user of the plurality of target users.

Clause 12: The system of clause 10 or 11, wherein the at least one server computer is further programmed or configured to: determine at least one predicted second region external to the first region for each target user from the first subset of users based at least partially on previous transaction history external to the first region for the target user and other users of the first subset of users; and determine at least one predicted second region external to the first region for each target user from the second subset of users based at least partially on other users of the plurality of users that were previously inactive for the predetermined time period and subsequently initiated transaction activity external to the first region.

Clause 13: The system of any of clauses 10-12, wherein the at least one target action comprises: identifying at least one offer for each user of the plurality of target users; and communicating the at least one offer to the user.

Clause 14: The system of any of clauses 10-13, wherein the at least one target action comprises approving at least one of the plurality of target users for transactions in the at least one second region.

Clause 15: The system of any of clauses 10-14, wherein the at least one target action comprises: generating at least one list of at least a portion of the plurality of target users associated with a first issuing institution; and communicating the at least one list to the first issuing institution.

Clause 16: The system of any of clauses 10-15, wherein the first region comprises a country or territory associated with each of the plurality of users.

Clause 17: The system of any of clauses 10-16, wherein the predetermined number of times is one.

Clause 18: A computer program product for generating recommendations based on predicted activity external to a first region, comprising at least one non-transitory computer-readable medium including program instructions that, when executed by at least one computer comprising at least one processor, cause the at least one processor to: segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times; generate an activation metric for each user of the first subset of users based at least partially on a frequency and/or temporal distribution of transactions external to the first region initiated by other users of the first subset of users; generate an activation metric for each user of the second subset of users based at least partially on previous transaction data for at least a portion of the plurality of users; determine a plurality of target users from the plurality of users based at least partially on the activation metric for each user of the plurality of users, the plurality of target users having a propensity for initiating transaction activity external to the first region; and automatically initiate at least one target action for each target user of the plurality of target users.

Clause 19: The computer program product of clause 18, wherein the program instructions, when executed by the at least one computer comprising the at least one processor, cause the at least one processor to determine at least one predicted second region external to the first region for each target user of the plurality of target users.

Clause 20: The computer program product of clause 18 or 19, wherein the program instructions, when executed by the at least one computer comprising the at least one processor, further cause the at least one processor to: determine at least one predicted second region external to the first region for each target user from the first subset of users based at least partially on previous transaction history external to the first region for the target user and other users of the first subset of users; and determine at least one predicted second region external to the first region for each target user from the second subset of users based at least partially on other users of the plurality of users that were previously inactive for the predetermined time period and subsequently initiated transaction activity external to the first region.

Clause 21: The computer program product of any of clauses 18-20, wherein the at least one target action comprises: identifying at least one offer for each user of the plurality of target users; and communicating the at least one offer to the user.

Clause 22: The computer program product of any of clauses 18-21, wherein the at least one target action comprises approving at least one of the plurality of target users for transactions in the at least one second region.

Clause 23: The computer program product of any of clauses 18-22, wherein the at least one target action comprises: generating at least one list of at least a portion of the plurality of target users associated with a first issuing institution; and communicating the at least one list to the first issuing institution.

Claus 24: The computer program product of any of clauses 18-23, wherein the first region comprises a country or territory associated with each of the plurality of users.

Clause 25: The computer program product of any of clauses 18-24, wherein the predetermined number of times is one.

These and other features and characteristics of the present invention, as well as the methods of operation and functions of the related elements or structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWING(S)

Additional advantages and details of the invention are explained in greater detail below with reference to the exemplary embodiments that are illustrated in the accompanying schematic figures, in which:

FIG. 1 shows a schematic diagram of one non-limiting embodiment or aspect of a system for generating recommendations based on predicted activity external to a first region according to the principles of the present invention;

FIG. 2 shows a schematic diagram of another non-limiting embodiment or aspect of a system for generating recommendations based on predicted activity external to a first region according to the principles of the present invention;

FIG. 3 shows a schematic diagram of another non-limiting embodiment or aspect of a system for generating recommendations based on predicted activity external to a first region according to the principles of the present invention;

FIG. 4 shows a step diagram of one non-limiting embodiment or aspect of a method for generating recommendations based on predicted activity external to a first region according to the principles of the present invention;

FIG. 5 shows a sequence diagram of one non-limiting embodiment or aspect of a method for generating recommendations based on predicted activity external to a first region according to the principles of the present invention;

FIG. 6 shows a sequence diagram of another non-limiting embodiment or aspect of a method for generating recommendations based on predicted activity external to a first region according to the principles of the present invention;

FIG. 7 shows a sequence diagram of another non-limiting embodiment or aspect of a method for generating recommendations based on predicted activity external to a first region according to the principles of the present invention;

FIG. 8 shows transaction data and graphical representations of a non-limiting embodiment or aspect of a method of generating an activation metric for a first subset of users according to the principles of the present invention;

FIG. 9 shows transaction data and a graphical representation of a non-limiting embodiment or aspect of a method of determining a predicted second region for each target user of a first subset of users according to the principles of the present invention;

FIG. 10A shows a graph of percent of captured traveling users over total population for a first subset of users using a method, system, and computer program product according to the principles of the present invention; and

FIG. 10B shows a graph of percent of captured traveling users over total population for a second subset of users using a method, system, and computer program product according to the principles of the present invention.

### DESCRIPTION OF THE INVENTION

For purposes of the description hereinafter, the terms “end,” “upper,” ‘lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “portable financial device” or “portable device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet application, a personal digital assistant, a pager, a security card, a computer, an access card, a wireless terminal, and/or a transponder, as examples. The portable financial device may include a volatile or a non-volatile memory to store information, such as an account identifier or a name of an account holder. A portable financial device transaction may refer to a transaction initiated with a portable financial device and an account identifier.

As used herein, the terms “issuing institution,” “portable financial device issuer,” “issuer,” or “issuer bank” may refer to one or more entities that provide accounts to customers for conducting payment transactions, such as initiating credit and/or debit payments. For example, an issuing institution may provide an account identifier, such as a personal account number (PAN), to a customer that uniquely identifies one or more accounts associated with that customer. The account identifier may be embodied on a portable financial device such as a physical financial instrument, e.g., a payment card, and/or may be electronic and used for electronic payments. As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they may be used to conduct a transaction without directly using the original account identifier. In some examples, an original account identifier, such as a PAN, may be associated with a plurality of tokens for different individuals or purposes. An issuing institution may be associated with a bank identification number (BIN) that uniquely identifies it. The terms “issuing institution” and “issuing institution system” may also refer to one or more computer systems operated by or on behalf of an issuing institution, such as a server computer executing one or more software applications. For example, an issuing institution system may include one or more authorization servers for authorizing a payment transaction.

As used herein, the term “merchant” refers to an individual or entity that provides goods and/or services, or access to goods and/or services, to customers based on a transaction, such as a payment transaction. The term “merchant” may also refer to one or more computer systems operated by or on behalf of a merchant, such as a server computer executing one or more software applications. As used herein, a “merchant point-of-sale (POS) system” may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that may be used to initiate a payment transaction. A merchant POS system may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and the issuing institution.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may be referred to as a “system,” such as a merchant's point-of-sale system.

Non-limiting embodiments or aspects of the present invention are directed to a method, system, and computer program product for generating recommendations based on predicted activity external to a first region. Non-limiting embodiments or aspects of the invention allow for issuing institutions and/or transaction service providers to more efficiently determine each user's propensity to make purchases from foreign merchants using their portable financial device, even without details regarding domestic transactions, which are unavailable in certain countries. Thus, the invention allows issuing institutions and/or transaction service providers to avoid false fraud alerts from a user's legitimate foreign transactions and to offer the user timely travel benefits and/or incentives. Further, the invention may also allow issuing institutions and/or transaction service providers to predict which geographical region a user may visit so that the benefits and/or incentives offered include benefits and incentives useful in that geographical region.

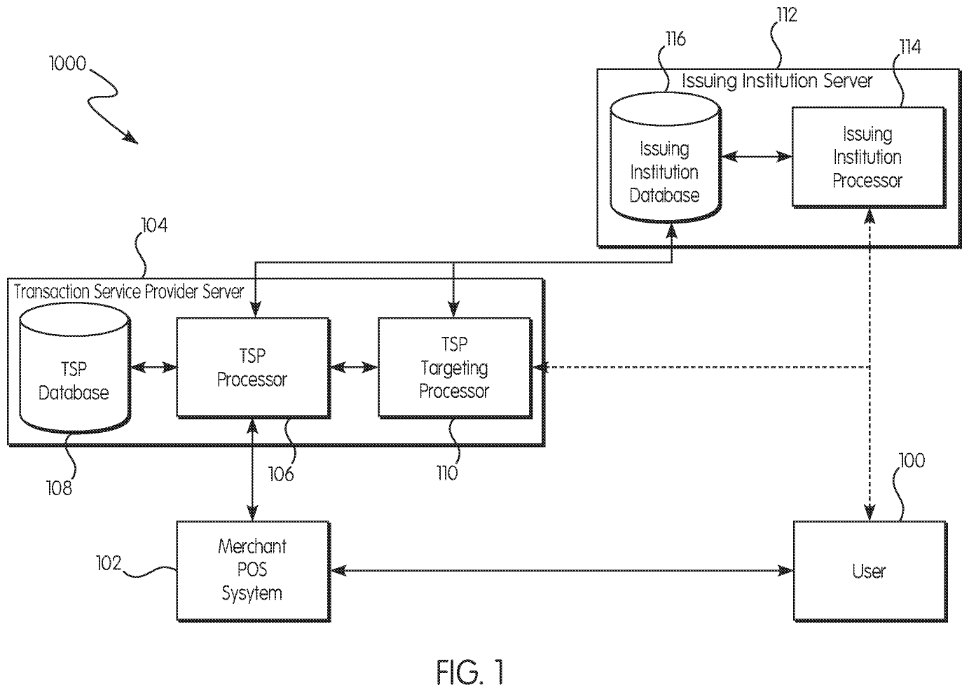

Referring to FIG. 1, illustrated is one non-limiting embodiment or aspect of a system 1000 for generating recommendations based on predicted activity external to a first region. A user 100 may be a holder of a portable financial device (e.g., an account holder) associated with a transaction service provider and issued to the user 100 by an issuing institution. The user 100 may use the portable financial device to initiate a financial transaction with a merchant point-of-sale system 102 (hereinafter “merchant POS system”) of a merchant. In some non-limiting embodiments or aspects, the user 100 may purchase goods and/or services from the merchant (via the merchant POS system 102) using a portable financial device to guarantee payment for the goods and/or services by authorization requests approved by a transaction service provider server 104 of a transaction service provider. The transaction between the user 100 and the merchant POS system 102 may be an in-person transaction, such as at a merchant's brick-and-mortar location (e.g., a face-to-face transaction). The transaction between the user 100 and the merchant POS system 102 may be a card-not-present (CNP) transaction, such as a transaction initiated by mail, by facsimile transmission, over the telephone, or over the internet, such as using a smartphone application or web browser.

With continued reference to FIG. 1, the user 100 may reside in a first region. As used herein, the term “reside” may mean that the user 100 is a citizen, permanent resident, or non-permanent resident in the first region. The user 100 may live at an address in the first region, and the user's account may be associated with that address. A user account may be associated with an address, residence, or place of business. The user 100 may be a holder of a portable financial device in the first region. For instance, the user's 100 mailing address and/or billing address may be located in the first region. The first region may be any definable geographic region. In some non-limiting embodiments or aspects, the first region is a neighborhood, township, town, municipality, borough, city, district, county, parish, state, commonwealth, province, territory, colony, country, continent, hemisphere, or some collection or combination thereof. The first region may also be any other arbitrarily defined geographical area, as determined by the transaction service provider or the issuing institution of the portable financial device. At least one second region may be defined as an area geographically outside of (external to) the first region. In some non-limiting embodiments or aspects, the first region is a specific first country associated with a user account, and the second region is a specific country or countries, or every other country except the first country, such as the first region being the United States of America and the second region being all other countries. In some non-limiting embodiments or aspects, the first region is a specific first country associated with a user account, and the second region a different country from the first country, such as the first region being the United States of America and the second region being Canada. In some non-limiting embodiments or aspects, the first region is a specific first state, and the second region is every other state except the first state, as well as every other country, such as the first region being Pennsylvania and the second region being all other states in the United States of America, as well as every other country. In some non-limiting embodiments or aspects, the first region is a specific first state, and the second region a specific state different from the first state, such as the first region being Pennsylvania and the second region being California. In some examples, the second region may be a subset of regions external to the first region.

The merchant selling goods or services to the user 100 and associated with the merchant POS system 102 may be a domestic merchant or a foreign merchant. “Domestic merchant” may refer to a merchant located in or that initiates a transaction in the first region associated with the user 100. “Foreign merchant” may refer to a merchant located in or initiating a transaction in the second region associated with the user 100. Whether the merchant is a domestic merchant or a foreign merchant may be based on the location at which the transaction between the user 100 and the merchant POS system 102 is considered to take place. For instance, a transaction may be considered to take place at a brick-and-mortar location (whether it be in the first region or second region associated with the user 100) of the merchant if the user 100 is physically present in the brick-and-mortar location to initiate the transaction. As another example, a transaction may be considered to take place in the first region of the user 100 when the transaction is initiated with the merchant POS system 102 online and billed and/or shipped to the user's 100 address in the first region 100. However, any other relevant transaction scenario may be considered when determining the location of the transaction.

With continued reference to FIG. 1, the transaction service provider server 104 may include a transaction service provider processor 106, a transaction service provider database 108, and a transaction service provider targeting processor 110. The transaction service provider processor 106 and the transaction service provider targeting processor 110 may be managed by or on behalf of the transaction service provider. In some non-limiting embodiments or aspects, the transaction service provider processor 106 and the transaction service provider targeting processor 110 may be the same or separate processors. The transaction service provider processor 106 and the transaction service provider targeting processor 110 may be located at the transaction service provider or elsewhere. The transaction service provider database 108 may be managed by or on behalf of the transaction service provider. It will be appreciated that the transaction service provider server 104 may include other computers, processors, databases, and the like.

With continued reference to FIG. 1, the merchant POS system 102 may communicate with the transaction service provider processor 106 during financial transactions between the user 100 and the merchant. During these transactions, the transaction service provider processor 106 may collect transaction data relating to the financial transactions and communicate that data to a transaction service provider database 108. The transaction service provider database 108 may be located at the transaction service provider or elsewhere. Over time, the transaction service provider database 108 may store historical transaction data (e.g., prior transaction data) and other information about a plurality of users who use portable financial devices associated with the transaction service provider. For instance, the transaction service provider processor 106 may collect various information about each of its account holders, including information about each purchase or each non-purchase transaction (e.g., an automated teller machine transaction or account funding transfer transaction) that account holder has made using the portable financial device associated with the transaction service provider. This historical transaction data may be analyzed later by the transaction service provider processor 106.

In some non-limiting embodiments or aspects, the transaction service provider database 108 may include the following transaction data: personal account number (PAN), transaction date, channel of purchase (e.g., face-to-face (F2F) or card-not-present (CNP)), a total spending for each channel of purchase, a volume of transactions for each channel, a transaction amount, a card type, a country of purchase, a frequency of transactions, a transaction spend, a merchant category, a consistency of usage, a frequency or amount of electronic commerce transactions, a frequency of transactions in the at least one second region, a transaction spend in the at least one second region, a consistency of transactions in the at least one second region, past travel behavior, merchant preferences, amount or frequency of seasonal purchases, a number of channels though which user has initiated a transaction, spend behavior, or any combination thereof. It will be appreciated that this list of categories of transaction data and/or transaction parameters within the categories of transaction data is not limited to the above list, and any relevant parameters may also be included.

In some countries, not every parameter of transaction data listed above is available to the transaction service provider processor 106 and, therefore, cannot be collected and stored in the transaction service provider database 108. This more limited transaction data collected may include a subset of the above-listed transaction data. In some non-limiting embodiments or aspects, transaction data related to the specific merchant, specific goods purchased, and specific market category of the merchant may be unavailable in certain countries, such as China. The more limited transaction data may include: PAN number, transaction date, channel of purchase, amount of purchase, merchant category (for merchants outside of certain countries only), total spending for each channel of purchase, card type, country of purchase, and/or volume of transactions for each channel. However, it will be appreciated that any data available to the transaction service provider processor 106 may be collected and stored in the transaction service provider database 108.

With continued reference to FIG. 1, the issuing institution may have an issuing institution server 112. The issuing institution server 112 may include an issuing institution processor 114 and an issuing institution database 116. The issuing institution processor 114 may be managed by or on behalf of the issuing institution and may be located at or remote from the issuing institution. The issuing institution database 116 may be managed by or on behalf of the issuing institution and may be located at or remote from the issuing institution. It will be appreciated that the issuing institution server 112 may include other computers, processors, databases, and the like.

With continued reference to FIG. 1, the transaction service provider processor 106 may communicate with the issuing institution database 116 which, like the transaction service provider database 108, may include information about each user. The information collected about each user and stored in the issuing institution database 116 may be collected by the issuing institution processor 114. In some non-limiting embodiments or aspects, the issuing institution database 116 may include the following information: personal information (e.g., name, age, gender, mailing address, phone number, email address, social security number, driver's license number, marital status, occupation, and/or the like) and/or various financial information (e.g., credit score, credit score history, bank account number, account identifier, monthly salary, yearly salary, and/or the like). Some of the information in the transaction service provider database 108 and the issuing institution database 116 may be duplicative. The data stored in the issuing institution database 116 may also be considered transaction data.

Certain other information may be stored in a database in communication with the transaction service provider processor 106 that also constitutes relevant transaction data. This information may include publicly available information. This publicly available information may include, for example, a number of holidays for various countries, dates of the holidays in various countries, events occurring in various countries popular to travelers, dates of the events occurring in various countries popular to travelers, peak vacation dates for various countries, weather in various counties, and/or the like.

With continued reference to FIG. 1, the transaction service provider targeting processor 110 may be in communication with the transaction service provider processor 106. The transaction service provider targeting processor 110 may automatically initiate at least one target action. The target action may be initiated based on a communication between the transaction service provider targeting processor 110 and the transaction service provider processor 106. The target action may be the transaction service provider targeting processor 110 identifying at least one offer for user(s) and communicating the at least one offer to the user 100 or some group of users. Such communication may include a web-based communication, an email communication, a text message, a telephone call, a push notification, and/or an instant message. The communication may include at least one offer for the user(s). The offer may be any benefit, such as a discount, coupon, cash back, promotional item, sweepstakes, or any other incentive to the user 100. For example, an offer may be related to travel, such as an offer for typical travel products and/or services or offers for products and/or services typical for use or purchase in the second region. The communication may also be informational or associated with incentivizing the user 100 to use the portable financial device in connection with travel in the second region. The user 100 may also communicate with the transaction service provider targeting processor 110 using like communication methods.

With continued reference to FIG. 1, the target action may include the transaction service provider targeting processor 110 communicating with the issuing institution processor 114. The communication may include a list of target users associated with the issuing institution. The communication may enable the issuing institution processor 114 to offer a benefit to user(s), enroll user(s) in an incentive program, approve user(s) for initiating transactions in the second region, or take any other action based on the communication. The communication may include a list of target users. The target action may include the transaction service provider targeting processor 110 communicating with the transaction service provider processor 106 so that the transaction service provider processor 106 can take some action based on the communication. For instance, a target action may include the transaction service provider processor 106 automatically approving the user(s) for initiating transactions in the second region. This approval may be advantageous for avoiding a rejection of a transaction in the second region merely because the transaction is occurring in the second region or because that user neglected to place a foreign travel notice on the portable financial device being used. The target action may also include automatically registering a user in an incentive program. A target action may also include any other action directed to incentivizing, educating, or encouraging a user to use their portable financial device in the first region or second region.

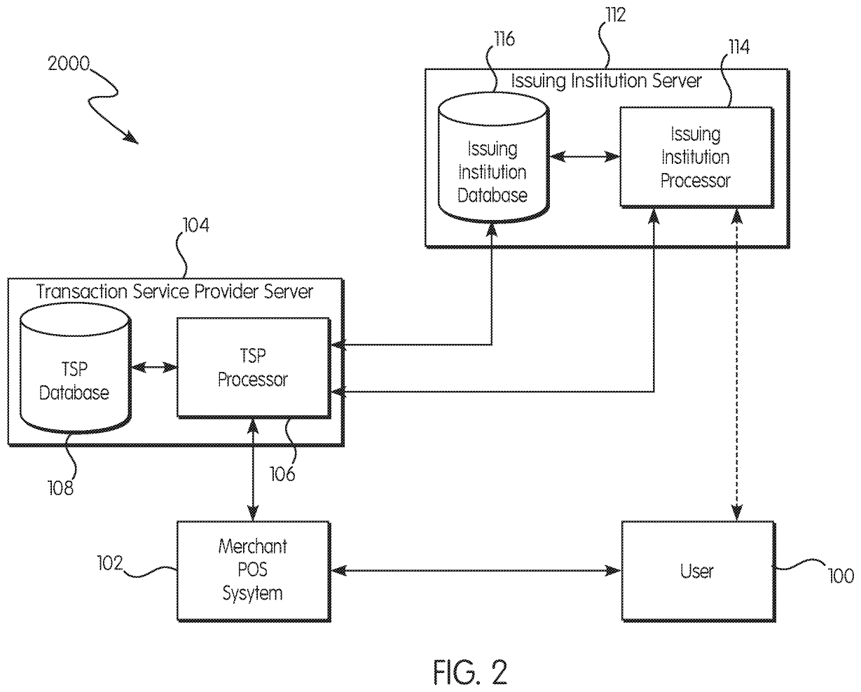

Referring to FIG. 2, illustrated is one non-limiting embodiment or aspect of another system 2000 for generating recommendations based on predicted activity external to a first region. The components of the system 2000 in FIG. 2 include all of the capabilities and characteristics of the components from the system 1000 of FIG. 1 having like reference numbers. In the non-limiting embodiment or aspect shown in FIG. 2, the transaction service provider processor 106 may communicate with the issuing institution processor 114. Based on this communication, the issuing institution processor 114 may automatically initiate one of the previously described target actions. For example, the issuing institution processor 114 may communicate a benefit to the user 100 or some group of users. The issuing institution processor may also communicate with the transaction service provider processor 106 so that the transaction service provider processor 106 may automatically approve the user(s) for initiating transactions in the second region.

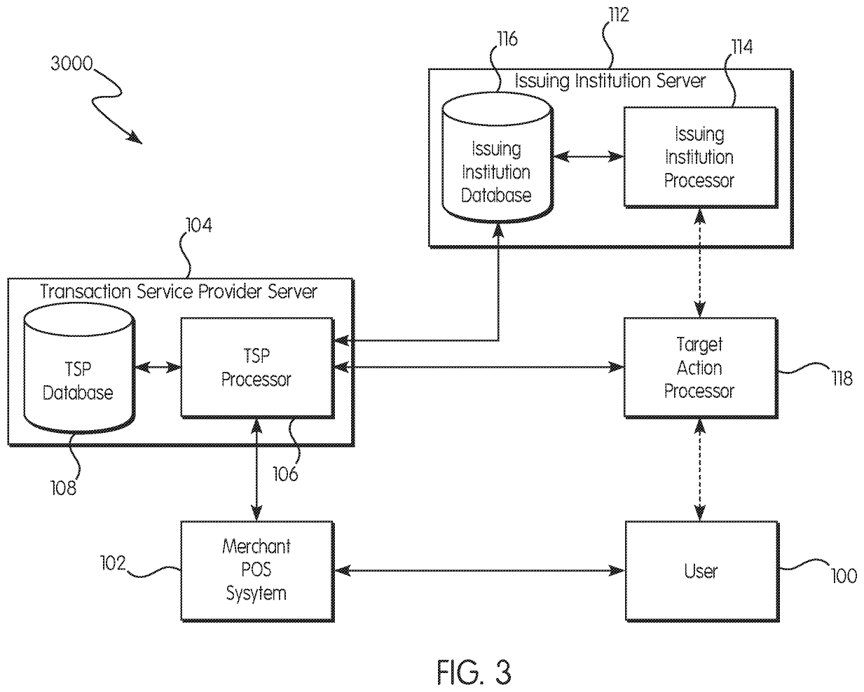

Referring to FIG. 3, illustrated is one non-limiting embodiment or aspect of another system 3000 for generating recommendations based on predicted activity external to a first region. The components of the system 3000 in FIG. 3 include all of the capabilities and characteristics of the components from the system 1000 of FIG. 1 having like reference numbers. In the non-limiting embodiment or aspect shown in FIG. 3, a target action processor 118 may be in communication with the transaction service provider processor 106. The target action processor 118 may be managed by or on behalf of the transaction service provider or the issuing institution. In some non-limiting embodiments or aspects, the target action processor 118 may be managed by or on behalf of an entity other than the transaction service provider and issuing institution.

With continued reference to FIG. 3, based on a communication from the transaction service provider processor 106, the target action processor 118 may automatically initiate one of the previously described target actions. For example, the target action processor 118 may communicate a benefit to the user 100 or some group of users. The target action processor 118 may communicate with the issuing institution processor 114, such as communicating a list, so that the issuing institution processor 114 can take further action (e.g., offering a benefit to user(s), enrolling user(s) in an incentive program, or approving user(s) for initiating transactions in the second region). The target action processor 118 may also communicate with the transaction service provide processor 106 so that the transaction service provider processor 106 may automatically approve the user(s) for initiating transactions in the second region.

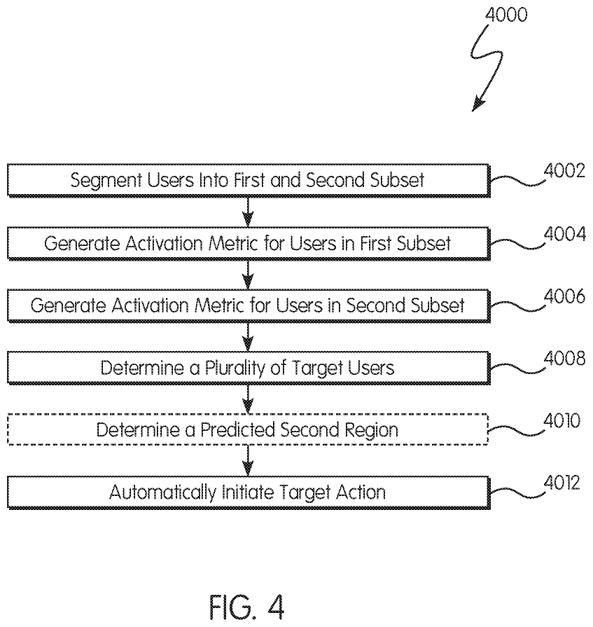

Referring to FIG. 4, illustrated is a step diagram of one non-limiting embodiment or aspect of a method 4000 for generating recommendations based on predicted activity external to a first region. With continued reference to FIG. 4, and referring to FIGS. 1-3, step 4002 may include segmenting a plurality of users into at least a first subset of users and a second subset of users. In some non-limiting embodiments or aspects, step 4002 may be performed by the transaction service provider processor 106. In other non-limiting embodiments or aspects, step 4002 may be performed by the transaction service provider targeting processor 110 or other processor (not shown) managed by or on behalf of the transaction service provider.

The first subset of users may include users that have previously used a portable financial device external to the first region within a predetermined time period to initiate a transaction at least a predetermined number of times. The predetermined time period may be any time period deemed relevant by the transaction service provider. The predetermined time period may be a previous day, week, month, year, or intervals thereof. In some non-limiting embodiments or aspects, the predetermined period is the previous twelve months. The predetermined number of times may be any number of times deemed relevant by the transaction service provider. The predetermined number of times may be a single transaction or multiple transactions. The second subset of users may include users that have previously used a portable financial device to initiate a transaction external to the first region within the predetermined time period less than the predetermined number of times. The predetermined time period and predetermined number of times may be the same or different for the first subset of users and the second subset of users. In some non-limiting embodiments or aspects, the predetermined period of time is the previous twelve months and the predetermined number of times is one for both the first subset of users and the second subset of users so that there is no overlap of users between the first subset of users and the second subset of users. In other non-limiting embodiments or aspects, the predetermined period of times and/or predetermined number of times for the first subset of users and the second subset of users may differ so that there may be some overlap in the users in the first subset of users and the second subset of users.

With continued reference to FIG. 4, and referring to FIGS. 1-3, step 4004 may include generating an activation metric for each user of the first subset of users based at least partially on a frequency and/or temporal distribution of transactions external to the first region initiated by other users of the first subset of users. The activation metric for the first subset of users may be generated by the transaction service provider processor 106. In other non-limiting embodiments or aspects, the activation metric for the first subset of users may be generated by the transaction service provider targeting processor 110 or other processor (not shown) managed by or on behalf of the transaction service provider. The activation metric may be generated based at least partially on a frequency and/or temporal distribution of transactions external to the first region (e.g., a historical travel pattern of each user) initiated by other users of the first subset of users. A user initiating a face-to-face transaction with a foreign merchant may indicate the historical travel pattern of the user, and available data from those transactions may be analyzed. Frequency and/or temporal distribution of transactions external to the first region for each user may be determined based on the transaction data stored in the transaction service provider database 108, including the transaction data associated with how frequently and when transactions external to the first region are initiated by each user. This transaction data may be analyzed by the transaction service provider processor 106.

The transaction data may include the previously listed transaction data, and may include only the transaction data available based on the country of the user 100 (e.g., only the more limited transaction data in certain countries). The transaction service provider processor 106 may analyze the transaction data deemed relevant to the frequency and/or temporal distribution of transactions external to the first region to generate the activation metric for each user of the first subset of users.

In one non-limiting embodiment or aspect, the transaction service provider processor 106 may analyze the transaction data using a Dynamic Time Warping (DTW) algorithm to measure the dissimilarity between each user in the first subset of users. In the DTW algorithm, a binary vector may represent a travel pattern based partially on time intervals, such as weekly intervals. The DTW dissimilarity may be calculated for each pair of users in the first subset of users to determine their dissimilarity with respect to one another. Clusters of users in the first subset of users may be created to further segment the users in the first subset of users, such that each subset includes users with similar travel patterns (based on relevant transaction data). The clustering may be performed using a K-means clustering method.

The activation metric may be based on a predictive model built for each of the clusters of the first subset of users. To develop the predictive model, any of the above-listed transaction data may be used. In some non-limiting embodiments or aspects, the transaction data used during the predictive modeling for each cluster includes number and total spending of cross-border (e.g., external to the first region) F2F transactions for relevant market segments, number of upcoming public holidays for various countries, and/or the like. A RuleFit machine learning algorithm may be applied using the transaction data and the clusters to create the predictive model (and therefore the activation metric) for each user in the first subset of users. It will be appreciated that various machine learning algorithms may be used. The predictive model may indicate a propensity of each user in the subset of users to travel abroad in a future time period. The future time period may be intervals of days, weeks, months, quarters, years, and the like. For examples, the future time period may be one year. The future time period may be 3-6 months.

With continued reference to FIG. 4, and referring to FIGS. 1-3, step 4006 may include generating an activation metric for each user of the second subset of users based at least partially on previous transaction data for at least a portion of the plurality of users. The activation metric for the second subset of users may be generated by the transaction service provider processor 106. In other non-limiting embodiments or aspects, the activation metric for the second subset of users may be generated by the transaction service provider targeting processor 110 or other processor (not shown) managed by or on behalf of the transaction service provider. The activation metric may be generated based at least partially on previous transaction data for at least a portion of the plurality of users. The previous transaction data may include any of the previously listed transaction data for transactions initiated by each of the plurality of users. The transaction data for the plurality of users, rather than just the transaction data for the second subset of users, may be used to generate the activation metric. Transaction data that may be used to generate the transaction metric for each of the second subset of users may include card type, volume of CNP transactions for certain market categories (in countries where this data is available), and the like. A RuleFit machine learning algorithm may be applied using the transaction data to create a predictive model, and the activation metric may be based at least partially off of this predictive model. It will be appreciated that other algorithms may be used. The predictive model may indicate a propensity of each user in the subset of users to travel abroad in a future time period. The future time period may be intervals of days, weeks, months, quarters, years, and the like. For examples, the future time period may be one year, 3-6 months, or any other time period.

With continued reference to FIG. 4, and referring to FIGS. 1-3, step 4008 may include determining a plurality of target users from the plurality of users based at least partially on the activation metric for each user of the plurality of users (including the first subset of users and the second subset of users), the plurality of target users having a propensity for initiating transaction activity external to the first region. The plurality of target users may be determined by the transaction service provider processor 106. In other non-limiting embodiments or aspects, the plurality of target users may be determined by the transaction service provider targeting processor 110 or other processor (not shown) managed by or on behalf of the transaction service provider.

The plurality of target users may include users from the first subset of users and the second subset of users having at least a minimum activation metric. The minimum activation metric may be the same for the first subset of users and the second subset of users. In other non-limiting embodiments or aspects, the minimum activation metric may be different for the first subset of users and the second subset of users. The plurality of target users may include users from the first subset of users and the second subset of users, whose activation metric indicates that they have at least a certain percentage likelihood to travel over the future time period. In some embodiments or aspects, all users having an activation metric that indicates at least a 30% likelihood of traveling to the second region(s) during the future time period, such as 40%, 50%, 60%, 70%, 80%, 90%, and the like may be included in the plurality of target users.

With continued reference to FIG. 4, and referring to FIGS. 1-3, step 4010 may include determining at least one predicted second region external to the first region for each target user of the plurality of target users. The second region may be determined by the transaction service provider processor 106. In other non-limiting embodiments or aspects, the second region may be determined by the transaction service provider targeting processor 110 or other processor (not shown) managed by or on behalf of the transaction service provider. In this step 4010, the transaction service provider processor 106 may determine the likely destination (e.g., specific second region) to which each user of the plurality of target users may travel outside of the first region. The determination may be a second region outside of the first region, such as a specific country or territory outside of the first region. For example, for a user living in China (as the first region), the transaction service provider processor 106 may determine the likely travel destination of the user to a second region, such as the United States or Singapore. The determination may be made by the transaction service provider processor 106 for each of the plurality of target users based on whether they are a user in the first subset of users or the second subset of users.

For the plurality of target users from the first subset of users, prior travel history (based on the previously listed transaction data) may be used for each user from the first subset of users. The determination may be based at least partially on previous transaction history external to the first region for the target user and other users of the first subset of users. A similarity matrix across all possible second regions for the first subset of users may be generated. For each target user in the plurality of target users from the first subset of users, a score may be generated for each possible second region. The score may be a weighted sum of the similarity to other possible second regions. The weight may be based on frequency of travel to that possible second region. A score for each target user in the plurality of target users from the first subset of users may be generated for each possible second region to predict where that user may travel in the future time period.

For the plurality of target users from the second subset of users, the determination may be based at least partially on others users of the plurality of users that were previously inactive for the predetermined time period and subsequently initiated transaction activity external to the first region. This determination may consider transaction data for the plurality of users, rather than just target users or users in the second subset of users. In some non-limiting embodiments or aspects, the predetermined period of time is one year, and the future time period of 3-6 months. To determine where a target user in the plurality of target users from the second subset of users may travel to (the second region), all users previously inactive in traveling to a second region (e.g., users that have not traveled to a second region external to the first region) (based on transaction data) over a one year period of time but that then traveled to a second region in the subsequent 3-6 months may be considered in the determination. Based partially on the transaction data from this group, a second region to which each user in the second subset of users may travel may be determined by the transaction service provider processor 106.

With continued reference to FIG. 4, and referring to FIGS. 1-3, step 4012 may include automatically initiating at least one target action for each target user of the plurality of target users. The target action may be initiated by the transaction service provider processor 106, the transaction service provider targeting processor 110, the issuing institution processor 114, the target action processor 118, some other processor, or any combination of such processors. In non-limiting embodiments or aspects in which the transaction service provider processor 106 does not perform the target action, the transaction service provider processor 106 may communicate the determined plurality of target users (such as a list of target users) to the processor initiating the target action. In other non-limiting embodiments or aspects, the processor determining the plurality of target users but not initiating the target action may communicate the list of the plurality of target users to the processor performing the target action. The target action may be any of the previously described target actions.

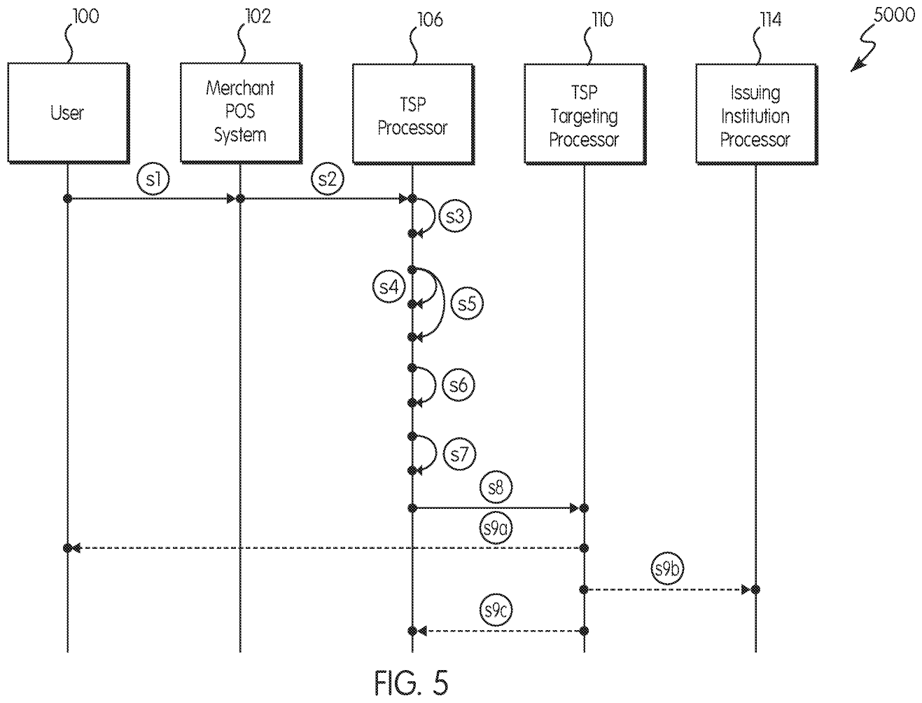

Referring to FIG. 5, illustrated is a sequence diagram of one non-limiting embodiment or aspect of a method 5000 for generating recommendations based on predicted activity external to a first region. With reference to FIG. 5 and referring back to FIG. 1, at a first step (s1) a transaction between the user 100 and the merchant POS system 102 may be initiated. The transaction may be a purchase of goods and/or services from the merchant in exchange for a monetary value. The transaction may be initiated using the user's 100 portable financial device. At a second step (s2), the merchant POS system 102 may communicate transaction data associated with the transaction to the transaction service provider processor 106. The transaction data communicated by the merchant POS system 102 to the transaction service provider processor 106 may include the previously described transaction data, and the transaction data communicated may be based on the country of the transaction. For example, in certain countries a more limited set of transaction data may be communicated to the transaction service provider processor 106. The transaction service provider processor 106 may collect and store this transaction data in the transaction service provider database 108. Transaction data may be collected and stored in the transaction service provider database 108 for each transaction initiated with a portable financial device associated with the transaction service provider.

Referring to FIGS. 1, 4, and 5, at a third step (s3), the transaction service provider processor 106 may segment the plurality of users into at least the first subset of users and the second subset of users. This segmentation may be performed by the transaction service provider processor 106 as described in connection with step 4002 of the method shown in FIG. 4.

With continued reference to FIGS. 1, 4, and 5, at a fourth step (s4), the transaction service provider processor 106 may generate an activation metric for the users in the first subset of users. The activation metric for the users in the first subset of users may be generated by the transaction service provider processor 106 as described in connection with step 4004 of the method shown in FIG. 4.

With continued reference to FIGS. 1, 4, and 5, at a fifth step (s5), the transaction service provider processor 106 may generate an activation metric for the users in the second subset of users. The activation metric for the users in the second subset of users may be generated by the transaction service provider processor 106 as described in connection with step 4006 of the method shown in FIG. 4.

With continued reference to FIGS. 1, 4, and 5, at a sixth step (s6), the transaction service provider processor 106 may determine a plurality of target users. The plurality of target users may be determined by the transaction service provider processor 106 as described in connection with step 4008 of the method shown in FIG. 4.

With continued reference to FIGS. 1, 4, and 5, at a seventh step (s7), the transaction service provider processor 106 may determine a predicted second region for each of the plurality of target users. The predicted second region for each of the plurality of target users may be determined by the transaction service provider processor 106 as described in connection with step 4010 of the method shown in FIG. 4.

Referring to FIGS. 1 and 5, at an eighth step (s8), the transaction service provider processor 106 may communicate with the transaction service provider targeting processor 110. The transaction service provider processor 106 may communicate the plurality of target users and/or the determined second region for each of the plurality of target users to the transaction service provider targeting processor 110.

Referring to FIGS. 1 and 5, at a ninth step (s9a-s9c), the transaction service provider targeting processor 110 may automatically initiate a target action for each user of the plurality of target users. The transaction service provider targeting processor 110 may communicate with the plurality of target users as the target action (s9a), such as to offer the user(s) a benefit or provide information or otherwise incentivize the user 100 to use the portable financial device in connection with travel in the second region. The transaction service provider targeting processor 110 may communicate with the issuing institution processor 114 as the target action (s9b). The transaction service provider targeting processor 110 may communicate the plurality of target users and/or the determined second region for the plurality of target users so that the issuing institution processor 114 may take further action, such as offering a benefit to the plurality of target users or enrolling the plurality of target users in an incentive program or approving users for initiating transactions in the second region. The transaction service provider targeting processor 110 may communicate with the transaction service provider processor 106 as the target action (s9c) so that the transaction service provider processor 106 may automatically approve the user(s) for initiating transactions in the second region, to avoid unnecessary fraud alerts.

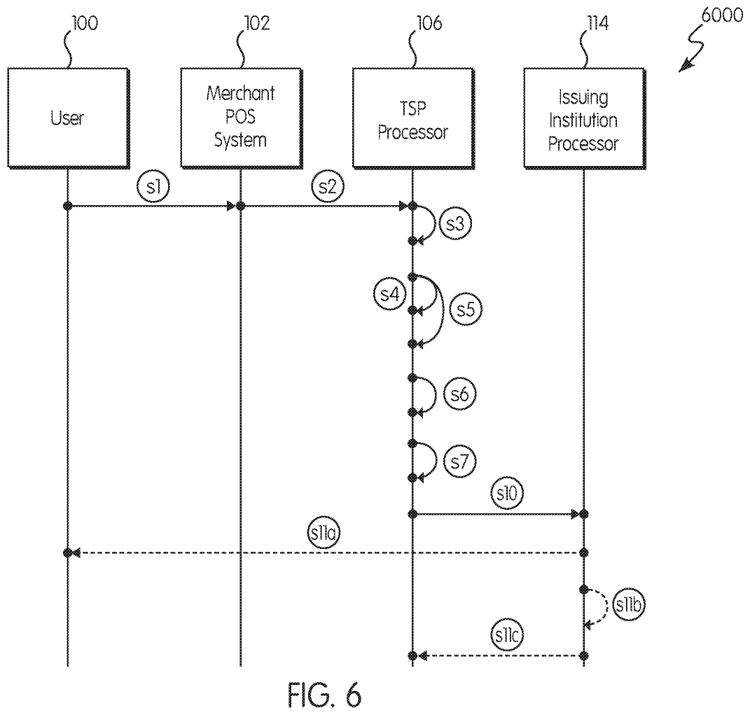

Referring to FIG. 6, illustrated is a sequence diagram of one non-limiting embodiment or aspect of a method 6000 for generating recommendations based on predicted activity external to a first region. With continued reference to FIG. 6 and referring back to FIG. 2, the method 6000 shown in FIG. 6 may include all of the steps of the method 5000 shown in FIG. 5000 having like reference numbers (s1-s7). At a tenth step (s10), the transaction service provider processor 106 may communicate with the issuing institution processor 114. The transaction service provider processor 106 may communicate the plurality of target users and/or the determined second region for each of the plurality of target users to the issuing institution processor 114 or take other relevant action.

Referring to FIGS. 2 and 6, at an eleventh step (s11a-s11c), the issuing institution processor 114 may automatically initiate a target action for each user of the plurality of target users. The issuing institution processor 114 may communicate with the plurality of target users as the target action (s11a), such as to offer the user(s) a benefit or provide information or otherwise incentivize the user 100 to use the portable financial device in connection with travel in the second region. The issuing institution processor 114 may perform any other processing step based on the information communicated from the transaction service provider processor as the target action (s11b), such as automatically registering the plurality of target users in an incentive program or approving users for initiating transactions in the second region. The issuing institution processor 114 may communicate with the transaction service provider processor 106 as the target action (s11c) so that the transaction service provider processor may automatically approve the user(s) for initiating transactions in the second region to avoid unnecessary fraud alerts or may take other relevant action.

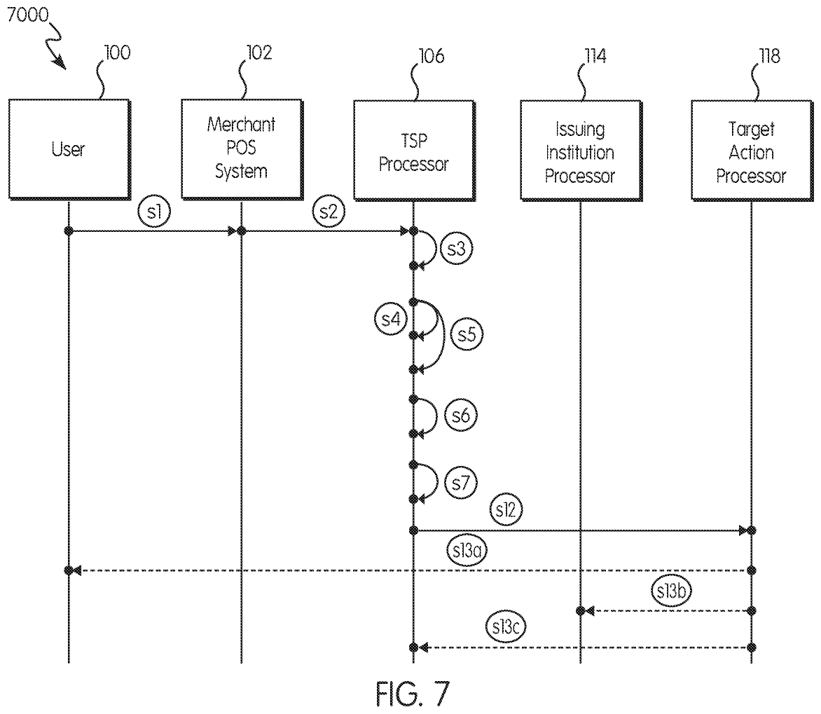

Referring to FIG. 7, illustrated is a sequence diagram of one non-limiting embodiment or aspect of a method 7000 for generating recommendations based on predicted activity external to a first region. With continued reference to FIG. 7 and referring back to FIG. 3, the method 7000 shown in FIG. 7 may include all of the steps of the method 5000 shown in FIG. 5000 having like reference numbers (s1-s7). At a twelfth step (s12), the transaction service provider processor 106 may communicate with the target action processor 118. The transaction service provider processor 106 may communicate the plurality of target users and/or the determined second region for each of the plurality of target users to the target action processor 118.

Referring to FIGS. 3 and 7, at an thirteenth step (s13a-s13c), the target action processor 118 may automatically initiate a target action for each user of the plurality of target users. The target action processor 118 may communicate with the plurality of target users as the target action (s13a), such as to offer the user(s) a benefit or provide information or otherwise incentivize the user 100 to use the portable financial device in connection with travel in the second region. The target action processor 118 may communicate with the issuing institution processor 114 as the target action (s13b). The target action processor 118 may communicate the plurality of target users and/or the determined second region for the plurality of target users so that the issuing institution processor 114 may take further action, such as offering a benefit to the plurality of target users or enrolling the plurality of target users in an incentive program or approving users for initiating transactions in the second region. The target action processor 118 may communicate with the transaction service provider processor 106 as the target action (s13c) so that the transaction service provider processor may automatically approve the user(s) for initiating transactions in the second region, to avoid unnecessary fraud alerts or take other relevant action.

In a further non-limiting embodiment or aspect, a computer program product for generating recommendations based on predicted activity external to the first region includes at least one non-transitory computer readable medium including program instructions that, when executed by at least one processor, cause the at least one processor to execute one of the previously-described methods (e.g., method 4000, 5000, 6000, 7000). The at least one processor may include the transaction service provider processor 106, the transaction service provider targeting processor 110, the issuing institution processor 114, and/or the target action processor 118.

In some non-limiting embodiments, the computer program product may include a plurality of computer-readable media, such as a first computer-readable medium and a second computer-readable medium. The first computer-readable medium may be located at a transaction service provider. The second computer-readable medium may be located remotely from the transaction service provider, such as at the issuing institution. It will be appreciated that the computer program product may be distributed in any number of ways.

### Examples

The following examples are provided to illustrate various non-limiting embodiments or aspects of the system and method for generating recommendations based on predicted activity external to a first region and are not meant to limit the invention in any way.

### A. Determining Activation Metric for First Subset of Users

The transaction service provider processor 106 segments a plurality of users into at least a first subset of users and a second subset of users. The first subset of users includes users that have previously used a portable financial device external to the first region within a predetermined time period to initiate a transaction at least a predetermined number of times. In this example, the first subset of users includes all users from the plurality of users having used their portable financial device external to the first region at least one time in the past one year. The first subset of users includes at least User 1, User 2, and User 3. Users 1-3 reside in China (as the first region). The transaction service provider processor 106 determines the activation metric for Users 1-3.

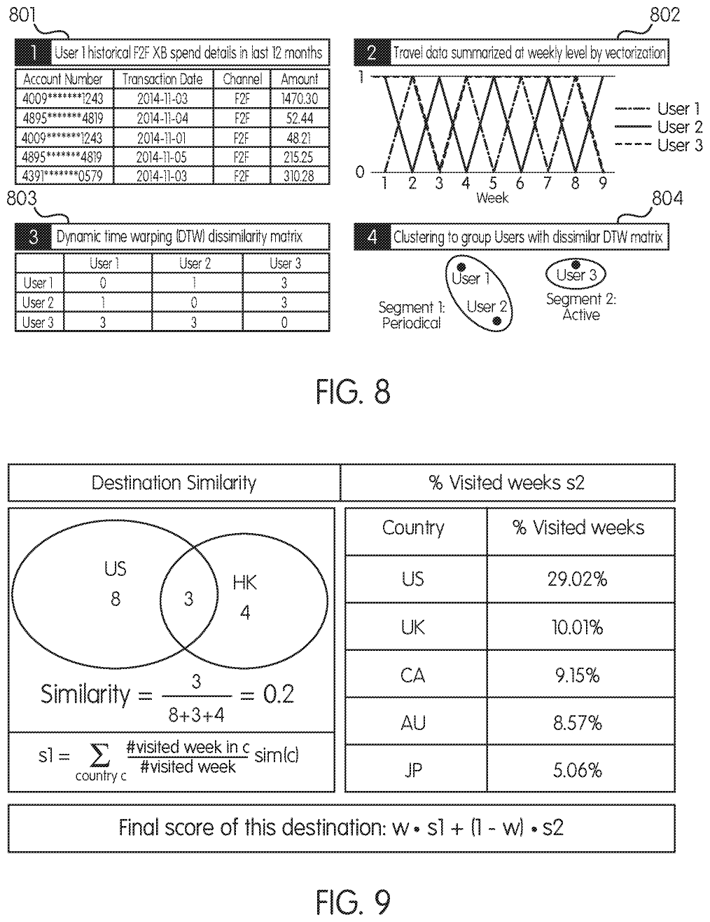

Referring to FIG. 8, illustrated is transaction data and graphical representations of a non-limiting embodiment or aspect of a method of generating an activation metric for User 1, User 2, and User 3 of the first subset of users. Historical cross-border (in a second region (e.g., countries other than China)) transaction data for each of Users 1-3 is analyzed by the transaction service provider processor 106. The table of FIG. 8 in the top left quadrant (801) shows historical cross-border transaction data for User 1. Cross-border transaction data includes transaction data collected in connection with a transaction initiated in the second region, including any of the previously listed transaction data relevant to transactions initiated in the second region. The table includes only face-to-face cross-border transactions. The data includes the PAN numbers, transaction date, transaction channel, and amount of each cross-border transaction of User 1, as these transactions indicate travel patterns of User 1. The table includes all cross-border transactions for User 1 over the past year. The table of transaction data for User 1 is exemplary and other tables may include more or less transaction data associate with User 1. Such a table is available for each user in the first subset of users, including User 2 and User 3.

A dynamic time warping (DTW) algorithm is utilized by the transaction service provide processor 106 to measure dissimilarity between Users 1-3. A binary vector represents travel patterns on some interval (such as a weekly interval over the course of the year) for each of Users 1-3 is generated. The graph in the top right quadrant (801) of FIG. 8 shows the binary vector travel pattern for Users 1-3 plotted on the same graph. Each vector represents whether the User initiated a F2F cross-border transaction that week. The DTW may generate a dissimilarity matrix (see bottom right quadrant (803) of FIG. 8. The dissimilarity matrix reflects the distance for each pair of Users (e.g. User 1 and User 2). The dissimilarity matrix in the present invention shows that Users 1 and 2 are more similar (less dissimilar) to each other since they have the same pattern of shifting every week. This can be seen from Quadrant 2 (802) as well by shifting the line for either User 1 or 2 to the left or right one week to overlap the plots of User 1 and User 2. The users are then clustered into segments with similar travel patterns by a K-means clustering method. The clustering is based on the DTW distance, and this is shown in the bottom right quadrant (804) of FIG. 8. User 1 and User 2 are in a single segment because they are proximate in DTW distance, while User 3 is in a separate segment based on DTW distance.

For each segment with similar travel patterns based on DTW distance, a predictive model to determine the activation metric is generated. Transaction data of each user is utilized. The transaction data in this example includes number and total of face-to-face transactions for certain market categories, such as the top 20 market categories, and a number of public holidays in the second region in the next future period of time, the future period of time being 3-6 months in this example. A RuleFit algorithm is an adaptive boosting model built on top of decision trees and linear regression, and a RuleFit algorithm is used to generate the predictive model to determine the activation metric for Users 1-3. The RuleFit algorithm employs sampling to reduce variance and is capable of ranking the importance of the various transaction data and the importance of the rules and/or decision trees. The result of this algorithm is an activation metric for each of User 1-3 to determine if User 1-3 falls into the plurality of target users who will likely travel in the next 3-6 months. The plurality of target users includes users who have a likelihood of 50% or greater to travel cross-border in the next 3-6 months.

### B. Determining Predicted Second Region for First Subset of Users

The transaction service provider processor 106 determines at least one predicted second region external to the first region for each target user of the plurality of target users from the first subset of users. The first subset of users includes users that have previously used a portable financial device external to the first region within a predetermined time period to initiate a transaction at least a predetermined number of times. In this example, the first subset of users includes all users from the plurality of users having used their portable financial device external to the first region at least one time in the past one year. In this example, the predicted second region is determined differently for the first subset of users compared to the second subset of users. In this example, a User in the first subset of users lives in Singapore, and the transaction service provider processor 106 determines which second region(s) (countries other than Singapore) User will likely visit in a future period of time, which is in the next 3-6 months. User is in the first subset of users.

Referring to FIG. 9, illustrated is transaction data and a graphical representation of a non-limiting embodiment or aspect of a method of determining a predicted second region for User. The method utilizes the number of visited weeks in the destination as representative of the attraction of the likelihood of User to travel to the destination. The transaction service provider processor 106 creates a similarity matrix across all destinations (second regions) visited by users in the first subset of users based on past transaction data. The similarity between two destinations is considered to be the number of common visited weeks divided by the number of total visited weeks. The destination similarity for the United States and Hong Kong is shown in FIG. 9, where the number of common visited weeks is 3 and the total visited weeks is 15, such that the similarity between the United States and Hong Kong is 0.2.

After determining a destination similarity, a score is calculated for User (and every other target user in the first subset of users) for each destination as a weighted sum of the similarity to other destinations. The weight in this example is visiting frequency because the method considers the number of visited weeks in the destination as representative of the attraction of the likelihood of User to travel to the destination.

Given transaction data for User and a destination, the individual score for User for the destination is f1, which is the weighted sum of the similarity between this destination and each visited destination, where the weight is the portion of visited weeks of this corresponding destination. A global score f2 of the destination is the portion of visited weeks for this destination by all users in the first subset of users over all destinations. FIG. 9 shows the percent of visited weeks for the top 5 destinations for users in the first subset of users that contribute to determining f2. The final score of the destination for User is a weighted sum of the individual score and the global score. The optimal weight (w) is obtained by a gradient descent algorithm.

### C. Performance Based on the Present Invention

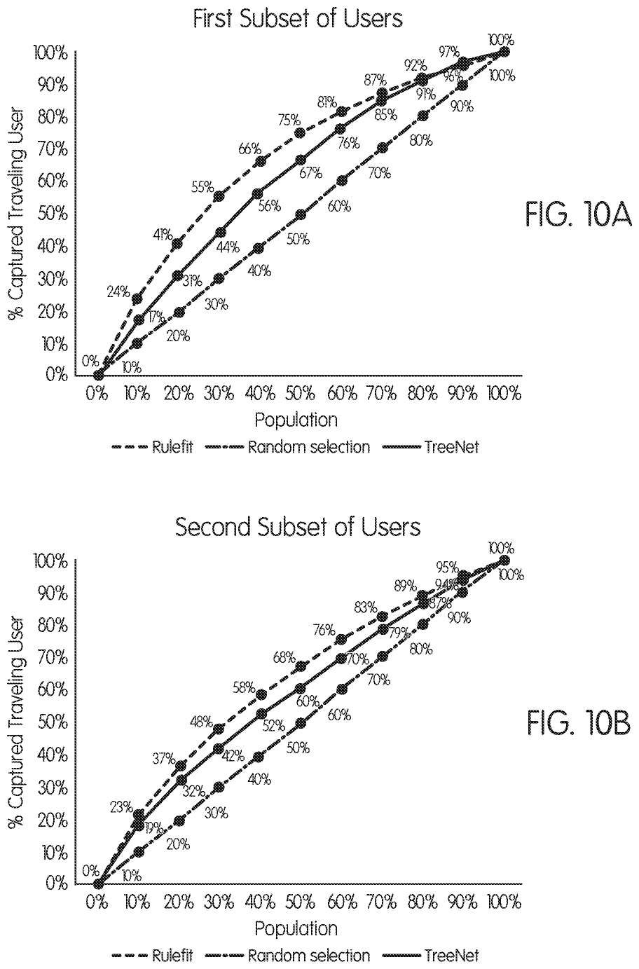

Referring to FIG. 10A, illustrated is a graph of percent of captured traveling users over total population for the first subset of users in a non-limiting example of one of the previously described systems (1000, 2000, 3000) or methods (4000, 5000, 6000, 7000) or any other system or method according to principles of the present invention. As can be seen in FIG. 10A the method and system of the present invention allows for a better prediction of propensity to conduct F2F cross-border transactions for users in the first subset of users. In a random selection, capturing 50% of the population would capture 50% of the traveling users, as no steps have been taken to accurately predict whether the selected users will travel cross-border. Using a TreeNet technique, capturing 50% of the population would capture 67% of traveling users, making an improvement over the random selection method. The method and system according to the current invention (RuleFit) outperforms both the random selection and TreeNet technique. In the illustrated example, capturing 50% of the population will capture 75% of the traveling users. Therefore, the present invention allows for more accurately targeting users that will travel in the future. This allows for those users to be communicated timely offers for use during their travel and to avoid transactions of the users being denied because the transaction is occurring cross-border and the user neglected to contact the transaction service provider to put a foreign travel notice on the portable financial device.

Referring to FIG. 10B, illustrated is a graph of percent of captured traveling users over total population for the second subset of users in one non-limiting example of one of the previously described systems (1000, 2000, 3000) or methods (4000, 5000, 6000, 7000) or any other system or method according to principles of the present invention. As can be seen in FIG. 10B the method and system of the present invention allows for a better prediction of propensity to conduct F2F cross-border transactions for users in the second subset of users. In a random selection, capturing 50% of the population would capture 50% of the traveling users, as no steps have been taken to accurately predict whether the selected users will travel cross-border. Using a TreeNet technique, capturing 50% of the population would capture 60% of traveling users, making an improvement over the random selection method. The method and system according to the current invention (RuleFit) outperforms both the random selection and TreeNet technique. In the illustrated example, capturing 50% of the population will capture 68% of the traveling users. Therefore, the present invention allows for more accurately targeting users that will travel in the future. This allows for those users to be communicated timely offers for use during their travel and to avoid transactions of the users being denied because the transaction is occurring cross-border and the user neglected to contact the transaction service provider to put a foreign travel notice on the portable financial device.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

1. A computer-implemented method of generating recommendations based on predicted activity external to a first region, comprising:
segmenting, with at least one processor, a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times;
generating, with at least one processor, an activation metric for each user of the first subset of users based at least partially on a frequency and/or temporal distribution of transactions external to the first region initiated by other users of the first subset of users;
generating, with at least one processor, an activation metric for each user of the second subset of users based at least partially on previous transaction data for at least a portion of the plurality of users;
determining, with at least one processor, a plurality of target users from the plurality of users based at least partially on the activation metric for each user of the plurality of users, the plurality of target users having a propensity for initiating transaction activity external to the first region; and
automatically initiating, with at least one processor, at least one target action for each target user of the plurality of target users.

2. The method of claim 1, further comprising determining, with at least one processor, at least one predicted second region external to the first region for each target user of the plurality of target users.

3. The method of claim 1, further comprising:
determining, with at least one processor, at least one predicted second region external to the first region for each target user from the first subset of users based at least partially on previous transaction history external to the first region for the target user and other users of the first subset of users; and
determining, with at least one processor, at least one predicted second region external to the first region for each target user from the second subset of users based at least partially on other users of the plurality of users that were previously inactive for the predetermined time period and subsequently initiated transaction activity external to the first region.

4. The method of claim 1, wherein the at least one target action comprises:
identifying at least one offer for each user of the plurality of target users; and
communicating the at least one offer to the user.

5. The method of claim 1, wherein the at least one target action comprises approving at least one of the plurality of target users for transactions in the at least one second region.

6. The method of claim 1, wherein the at least one target action comprises:
generating at least one list of at least a portion of the plurality of target users associated with a first issuing institution; and
communicating the at least one list to the first issuing institution.

7. The method of claim 1, wherein the first region comprises a country or territory associated with each of the plurality of users.

8. The method of claim 1, wherein the predetermined time period is twelve months.

9. The method of claim 1, wherein the predetermined number of times is one.

10. A system for generating recommendations based on predicted activity external to a first region, comprising at least one server computer including at least one processor, the at least one server computer programmed or configured to:
segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times;
generate an activation metric for each user of the first subset of users based at least partially on a frequency and/or temporal distribution of transactions external to the first region initiated by other users of the first subset of users;
generate an activation metric for each user of the second subset of users based at least partially on previous transaction data for at least a portion of the plurality of users;
determine a plurality of target users from the plurality of users based at least partially on the activation metric for each user of the plurality of users, the plurality of target users having a propensity for initiating transaction activity external to the first region; and
automatically initiate at least one target action for each target user of the plurality of target users.

11. The system of claim 10, wherein the at least one server computer is further programmed or configured to determine at least one predicted second region external to the first region for each target user of the plurality of target users.

12. The system of claim 10, wherein the at least one server computer is further programmed or configured to:
determine at least one predicted second region external to the first region for each target user from the first subset of users based at least partially on previous transaction history external to the first region for the target user and other users of the first subset of users; and
determine at least one predicted second region external to the first region for each target user from the second subset of users based at least partially on other users of the plurality of users that were previously inactive for the predetermined time period and subsequently initiated transaction activity external to the first region.

13. The system of claim 10, wherein the at least one target action comprises:
identifying at least one offer for each user of the plurality of target users; and
communicating the at least one offer to the user.

14. The system of claim 10, wherein the at least one target action comprises approving at least one of the plurality of target users for transactions in the at least one second region.

15. The system of claim 10, wherein the at least one target action comprises:
generating at least one list of at least a portion of the plurality of target users associated with a first issuing institution; and
communicating the at least one list to the first issuing institution.

16. The system of claim 10, wherein the first region comprises a country or territory associated with each of the plurality of users.

17. The system of claim 10, wherein the predetermined number of times is one.

18. A computer program product for generating recommendations based on predicted activity external to a first region, comprising at least one non-transitory computer-readable medium including program instructions that, when executed by at least one computer comprising at least one processor, cause the at least one processor to:
segment a plurality of users into at least a first subset of users and a second subset of users, the first subset of users comprising users that have previously used a portable device external to the first region within a predetermined time period to initiate a transaction at least a predetermined number of times, and the second subset of users comprising users that have previously used a portable device to initiate a transaction external to the first region within the predetermined time period less than the predetermined number of times;
generate an activation metric for each user of the first subset of users based at least partially on a frequency and/or temporal distribution of transactions external to the first region initiated by other users of the first subset of users;
generate an activation metric for each user of the second subset of users based at least partially on previous transaction data for at least a portion of the plurality of users;
determine a plurality of target users from the plurality of users based at least partially on the activation metric for each user of the plurality of users, the plurality of target users having a propensity for initiating transaction activity external to the first region; and
automatically initiate at least one target action for each target user of the plurality of target users.

19. The computer program product of clause 18, wherein the program instructions, when executed by the at least one computer comprising the at least one processor, cause the at least one processor to determine at least one predicted second region external to the first region for each target user of the plurality of target users.

20. The computer program product of claim 18, wherein the program instructions, when executed by the at least one computer comprising the at least one processor, further cause the at least one processor to:
determine at least one predicted second region external to the first region for each target user from the first subset of users based at least partially on previous transaction history external to the first region for the target user and other users of the first subset of users; and
determine at least one predicted second region external to the first region for each target user from the second subset of users based at least partially on others user of the plurality of users that were previously inactive for the predetermined time period and subsequently initiated transaction activity external to the first region.

21.-25. (canceled)
